(19) United States
(12) Patent Application Publication
(10) Pub. No.: US 2010/0134956 A1
(43) Pub. Date: Jun. 3, 2010

(54) SOLID ELECTROLYTIC CAPACITOR AND METHOD OF MANUFACTURING THE SAME

(75) Inventors: Kaoru Ueno, Tokyo (JP); Larry Dominey, N.E. Moses Lake, WA (US); Toshiki Wakabayashi, Tokyo (JP); Katsunori Nogami, Tokyo (JP)

Correspondence Address: YOUNG & THOMPSON, 209 Madison Street, Suite 500, Alexandria, VA, 22314, US

(73) Assignee: NIPPON CHEMI-CON CORPORATION, Tokyo (JP)

(21) Appl. No.: 12/443,274

(22) PCT Filed: Sep. 28, 2007
(86) PCT No.: PCT/US07/20899

§ 371 Date: Feb. 12, 2010

(30) Foreign Application Priority Data
Sep. 29, 2006 (US) PCT/US2006/038025
Oct. 27, 2006 (US) PCT/US2006/041960

(51) Int. Cl. H01G 9/02; H01G 9/00

(52) U.S. Cl. 361/525; 427/80

(57) ABSTRACT

A solid electrolytic capacitor with a high voltage resistance property and a method of manufacturing the same is disclosed. The solid electrolytic capacitor is formed including an electrolyte layer on an anode electrode formed of a metal oxide dielectric by a polymerization reaction in which the polymerizable monomer or the monomer solution is mixed with an oxidant, wherein a Lewis base having a steric hindrance group with a nitrogen atom or a Lewis base having a hydrophilic radical with a nitrogen atom is adhered to a surface of the dielectric or incorporated in the electrolyte layer.

### BACKGROUND OF THE INVENTION

1. Field of the Invention

The present invention relates to a solid electrolytic capacitor and a method of manufacturing the same and, more particularly to a solid electrolytic capacitor with high voltage resistance and a method of manufacturing the same.

2. Description of the Related Art

Conventionally, an electrolytic capacitor utilizing metal with valve action, such as aluminum, has been commonly used since when metal with valve action used as an anode electrode is formed into an etching foil and the like to obtain a surface-roughened dielectric, a downsized electrolytic capacitor with a large capacitance is provided. Particularly, a solid electrolytic capacitor employing a solid electrolyte has good properties such as small size, large capacitance, and low equivalent series resistance. In addition to these properties, ease of making this product into chips and suitability for surface mounting is important. As a result, the solid electrolytic capacitor is now indispensable for making electronic equipment smaller and more powerful.

A conductive polymer with high electrical conductance, which is excellent in adhesion to an oxide film layer of an anode electrode, has been used as a solid electrolyte employed in a solid electrolytic capacitor. There have been known, for example, the use of polyaniline, polythiophene, polyethylenedioxythiophene, and the like as the conductive polymers.

Polyethylenedioxythiophene (hereinafter referred to as PEDT) has received attention as a conductive polymer capable of achieving high voltage resistance against the thickness of an oxide film. A capacitor employing PEDT uses chemical oxidative polymerization is made as follows. A capacitor element, formed by winding anode electrode foils and cathode electrode foils via separators, is impregnated with EDT (ethylenedioxythiophene) and an oxidant solution. It is then heated to form a PEDT polymer layer between both electrodes to result in the formation of a solid electrolytic capacitor (Japanese Unexamined Patent Publication No. 9 (1997)-293639)

Such a solid electrolytic capacitor as described above can be used for in-car and inverter applications. There is disclosed that to resolve the problem that working voltage increases from 20 WV to 35 WV, withstand voltage is increased by forming a link composed of a compound having a vinyl group and a boric acid compound in a capacitor element (Japanese Unexamined Patent Publication No. 2003-100560).

### SUMMARY OF THE INVENTION

However, even with such art, the current voltage resistance is not good enough.

Accordingly, one object of the invention, which is proposed in order to resolve such problems of the prior art as described above, is to provide a solid electrolytic capacitor with high voltage resistance and a method of manufacturing the same.

### DETAILED DESCRIPTION

To achieve said object, a solid electrolytic capacitor is produced by forming an electrolyte layer on an anode electrode formed of a valve metal oxide dielectric by a polymerization reaction in which an oxidative polymerizable monomer or an oxidative polymerizable monomer solution is mixed with an oxidant, wherein a Lewis base having a steric hindrance group with a nitrogen atom or a Lewis base having a hydrophilic radical with a nitrogen atom is adhered to a surface of the dielectric.

Further, the solid electrolytic capacitor is characterized in that the solid electrolytic capacitor is produced by forming an electrolyte layer on an anode electrode formed of a valve metal oxide dielectric by a polymerization reaction in which an oxidative polymerizable monomer or an oxidative polymerizable monomer solution is mixed with an oxidant, wherein a Lewis base, having a steric hindrance group with a nitrogen atom, or a Lewis base, having a hydrophilic radical with a nitrogen atom, is contained in the electrolyte layer.

The anode electrode employed comprises aluminum or aluminum alloy.

The solid electrolytic capacitor is produced from an anodic electrode foil formed of an aluminum oxide dielectric wound with a cathodic electrode foil via a separator to prepare a capacitor element. The capacitor element is then dipped in an electrolytic solution in which an oxidative polymerizable monomer or an oxidative polymerizable monomer solution is mixed with an oxidant. A polymerization reaction of polymers that conduct electricity then occurs in the capacitor element to form a solid electrolyte layer. The capacitor element is then stored in an outer package and an open-end of the package is sealed with a sealing member made of elastic rubber.

Alternatively, an insulating resin band may be formed from a portion of an anodic electrode foil formed of aluminum oxide dielectric in order to distinguish between an extraction of the anodic electrode and the cathodic foil. The polymerizable monomer is then applied. Thereafter, the oxidant is applied to form the solid electrolyte layer. A graphite layer and a silver paste layer are then formed on the solid electrolyte layer sequentially in order to form an extraction of the cathodic electrode. Then, the extraction of the cathodic electrode and the external cathode terminal are connected with each other via the silver paste.

The polymerizable monomer employed includes, for example, ethylenedioxythiophene (EDT), chemical oxidative polymerization of which forms polyethylenedioxythiophene (PEDT). The use of 3,4-ethylenedioxythiophene as a polymerizable monomer forms poly(3,4-ethylenedioxythiophene) as the electrolyte layer.

Preferably, iron (III) p-toluenesulfonate dissolved in al-butanol solution is used as the oxidant.

A method in which a polymerizable monomer and an oxidant are impregnated and applied to a capacitor element can be employed utilizing a method of dipping the capacitor element in a mixing solution of a monomer and an oxidant. Another method is dipping a capacitor element in a monomer solution before dipping it in an oxidant solution, or discharging the monomer solution to a capacitor element before discharging an oxidant solution etc.

Then, a Lewis base having a steric hindrance group with a nitrogen atom or a Lewis base having a hydrophilic radical with a nitrogen atom is adhered to a surface of the dielectric, or a Lewis base having a steric hindrance group with a nitrogen atom or a Lewis base having a hydrophilic radical with a nitrogen atom is contained in the electrolyte layer.

The Lewis base employed in the present invention is a compound having at least one electron pair which is not shared or a lone pair. The Lewis base containing a nitrogen atom is a compound having a lone pair at the nitrogen atom, such as an amine, pyridine, imidazole or ammonia etc.

Further, the Lewis base having a steric hindrance group with a nitrogen atom comprises a substituted group near the lone pair of the nitrogen atom. The substituted groups constitute barriers to a reaction with the lone pair of the nitrogen and large cation. Such Lewis bases include 2,6-dimethylpyridine, 1,3-dimethyl-isoquinoline, 2,4-dimethyl-imidazole, 2,6-dimethyl-pyrazine, 1,8-Bis(dimethylamino) naphthalene (Proton-sponge), and Acridine.

Therefore, a proton, which is a relatively small cation, is able to react with the nitrogen atom selectively. The acidity of the oxidant should be kept close to neutral. Attacks by the oxidant to the anode electrode are suppressed, improving the electrode voltage resistance property and also the voltage resistance of the electrolytic capacitor.

Further, a Lewis base having a plane symmetric substituted group, could be employed. Such Lewis bases include 3,5-dimethylpyridine. The Lewis base is expected to have an electron density of the lone pair at the nitrogen atom increased due to the electron-releasing substituent. The reactivity with the proton is increased and accordingly, the acidity of the oxidant can be kept more basic. Attack by the oxidant to the anode electrode is suppressed. Thus, the electrode voltage resistance property and also the voltage resistance of the electrolytic capacitor are improved.

The chemical structural formulas of pyridine, 2,6-dimethylpyridine, and 3,5-dimethylpyridine Lewis bases, are shown below.

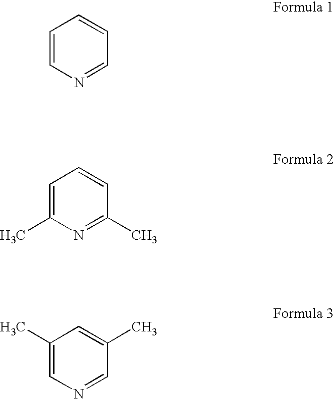

Further, the Lewis base having a hydrophilic radical with nitrogen atom is a Lewis base having a hydrophilic radical such as a hydroxyl group, carboxyl group, sulfonate group, amino group, amido group with nitrogen atom, such as triisopropanolamine, tris(2-hydroxy-propyl)amine=triisopropanolamine, tris (1-hydroxy-propyl)amine, tris(2-hydroxy-ethyl)amine, tris(2-amino-propyl)amine. As the Lewis base comprises a reaction with a proton of the nitrogen atom, the acidity of the electrolyte can be kept close to neutral. Further an oxide film is covered due to the good binding activity of the hydrophilic radical to the dielectric oxide film so that a chemical attack by the oxidant to the anode electrode is prevented. Thus the electrode voltage resistance property and also the voltage resistance of the electrolytic capacitor can be improved.

Further, the ammonia or amine comprises a structure with an ammonia molecule. The NH₃ group comprises a hydrogen binding to H₂0 having a high hydrophilic property in an aqueous solution, so that the effect can be provided.

As mentioned above, as the reactivity of the lone electron at the nitrogen atom is increased, the impact of the inventive product is also increased. Therefore, the preferred Lewis bases include a nitrogen atom, tertiary amine, such as tri-alkylamine, and aromatic amines, such as pyridine and imidazole.

When adhering the Lewis base to a surface of the dielectric, it is used for a method in which the wound capacitor element is impregnated with the solution of the Lewis base, dried and adhered, or the other method in which an insulating resin band is formed before the solution of the Lewis base is applied and adhered to a certain portion of a surface of a dielectric. Accordingly, the acidity of the oxidant can be kept close to neutral. Attacks by the oxidant on the anode electrode are suppressed. Thus the electrode voltage resistance property and also the voltage resistance of the electrolytic capacitor are improved.

Further, when the Lewis base is contained in the electrolyte layer, it is used in the polymerization reaction liquid for polymerizing the resultant mixture.

The following three methods can be used in the polymerization reaction.

In the first method the polymerizable monomer or monomer solution is adhered to the anode electrode. Then an oxidant solution is adhered thereto, Subsequent heating causes the polymerization reaction to proceed.

In the second method after adhering the oxidant solution to the anode electrode, the polymerizable monomer or the monomer solution is adhered thereto. Subsequent heating causes the polymerization reaction to proceed.

In the third method after mixing the polymerizable monomer or the monomer solution with the oxidant solution, the resultant mixture is adhered to the anode electrode, and subsequent heating causes the polymerization reaction to proceed.

In the first and second methods, the Lewis base is added to the monomer or the monomer solution and the oxidant solution. In the third method, the Lewis base is added to the mixture. With this feature, the acidity of the oxidant is relieved, an attack on the anode electrode due to the oxidant is Suppressed, the electrode voltage resistance property is improved, and the voltage resistance of the electrolytic capacitor is improved.

The plane symmetric dimethylpyridine has low vapor pressure and remains in a conductive polymer layer even after heating and oxidative polymerization.

### BRIEF DESCRIPTION OF THE DRAWINGS

FIG. 1 is a graph showing voltage-current properties of an Al/PEDT capacitor with a conventionally formed voltage oxide of 40 V;

FIG. 2 is a graph showing voltage-current properties after adding pyridine into the oxidant in PEDT polymerization of the capacitor of FIG. 1;

One embodiment of the present invention is described with the use of the drawings.

A solid electrolytic capacitor incorporates a Lewis base in an electrolyte layer for the formation of an electrolyte layer formed of polyethylenedioxythiophene (PEDT) on an anode electrode formed of aluminum by a polymerization reaction in which a polymerizable monomer or a monomer solution (EDT) is mixed with an oxidant.

The Al/PEDT capacitor, which will be used, has a very low equivalence series resistance (ESR) and high heat resistance that an Al electrolytic capacitor does not have, with significantly lower breakdown voltage than the voltage necessary for oxide formation and reduced leakage. It is suspected that low voltage resistance in the capacitor is caused by the dissolution or deterioration of an aluminum oxide film due to protons released from monomers during polymerization of Al oxide and the PEDT.

Hence, when a thicker voltage oxide film than that of an Al electrolytic capacitor to the rated voltage of an Al/PEDT capacitor is employed, in other words, when the ratio of working voltage to formation voltage (V_{w}/V_{f}) for the Al/PEDT capacitor is much smaller than that of the Al electrolytic capacitor is employed, the V_{w}/V_{f} ratio for the Al electrolytic capacitor is not more than 0.8, whereas the ratio for the Al/PEDT capacitor is less than 0.3. Accordingly, if the thickness of the oxide film can be reduced to almost as much as the Al electrolytic capacitor, and the V_{w}/V_{f} ratio can be increased, a high voltage product can be produced whereby electricity can be saved for oxide formation. Moreover, the capacitance of the Al/PEDT can be increased dramatically so that the capacitance is doubled by simply replacing 100 V oxide with 50 V oxide.

On the other hand, according to the voltage-current property of a Ta/PEDT capacitor, upon constantly charging current flows at a low electric field to a middle electric field, current increases exponentially near oxide film formation voltage, and finally breakdown voltage occurs. The breakdown voltage is close to the oxide film formation voltage, and its value is proportional to the oxide film formation voltage. Ta oxide is known as a very stable oxide, which is not dissolved or degraded by general acids, other than hydrofluoric acid. The Al/PEDT capacitor also has breakdown voltage close to the oxide film formation voltage, if the oxide film is not dissolved or degraded.

Furthermore, the Al oxide is dissolved or degraded in a 60 degree centigrade oxidant solution, and further the Al oxide is dissolved in molten p-toluenesulfonic acid of a byproduct at 150 degree centigrade.

Al oxide dissolution or degradation are important factors for low breakdown voltage or high leakage current. Accordingly, if the pH in a monomer/oxidant/PEDT mixture during a polymerization reaction is kept in a range that the Al oxide is stable (pH=3 to 10), it is possible to obtain a good voltage-current property. It is also possible to obtain breakdown voltage close to the oxide film formation voltage and low leakage current.

### EXAMPLES

The effect of some Lewis base additives on the Al/PEDT capacitor and on its voltage-current property was investigated in order to enhance conductivity.

### (Experiment)

### (Specimen and Pretreatment)

An Al plate with a thickness of 0.5 mm was cut into a 0.64 cm diameter circle. The specimen was immersed in a 85 vol % H₃P0₄ vol % HNO₃ mixture at 85 to 90 degree centigrade for 3 minutes, rinsed with water, rinsed with methanol, dried, and then stored in a desiccator. Just before anodic oxide formation, the specimen was immersed in 1 mol dm⁻3 NaOH at room temperature for 3 minutes, immersed in 10 vol % HNO₃ for 1 minute, rinsed with water, rinsed with methanol, and then dried.

### (Oxide Film Formation)

Anodic oxide was formed by applying a 0.83 mol dm⁻³ ammonium adipate solution with a current density of up to 1 mAcm⁻² until the desired formation voltage was reached, followed by maintaining the voltage for 10 minutes. The formed specimen was then rinsed with water, rinsed with methanol to remove water, dried and then stored in the desiccator.

### (Masking and Reformation)

The specimens were masked with a polyimide tape with a thickness not more than 0.05 mm to define the sample area (diameter of 6 mm). The reformation of oxide was carried out in the same electrolyte solution as was used for the oxide film formation by keeping at prescribed formation voltage for 1 minute in order to repair any damage that might be caused during masking.

### (Monomer and Oxidant)

The monomer and oxidant employed were 3,4-ethylenedioxythiophene (Baytron®MV2) and a 54 wt % iron (III) p-toluenesulfonate 1-butanol solution (Baytron®C-B54), respectively. In order to investigate the effect of Lewis base additives, oxidant solutions containing pyridine with a molar ratio of 0.9, 2,6-dimethylpyridine, and 3,5-dimethylpyridine were used.

### (Polymer Coating on Al Oxide and Electrical Contact)

After mixing said monomer and said oxidant solution thoroughly at a molar ratio of 1.0/0.3, the mixture was deposited on the Al oxide film to form a PEDT film. For the oxidant without a Lewis base, the specimen was spun at 600 rpm for 20 seconds to obtain a uniform film. For the oxidant with a Lewis base, spin coating was not employed since most of the mixture flew off a spinning disc due to its lower viscosity resulting from the fact that the addition of the Lewis base causes the polymerization rate to slow down. So the mixture was spread by tilting the specimen to cover the whole sample area. The polymer synthesis was carried out at 60 degree centigrade for 30 minutes, followed by 90 degree centigrade or 150 degree centigrade for 60 continuous minutes. Electrical contact between a Cu wire and the PEDT film was made with an silver paste.

### (Voltage-Current Curve Measurement)

The specimens were set in a stainless chamber with a drying agent (P₂O₅) After leaving for 1 to 2 days, a voltage-current (V-i) curve was measured by applying ramp voltage with 100 mVs⁻¹. Current was determined from voltage on resistance with 100 or 10 kΩ.

### Conventional Example

There is shown below the effect of polymerization temperature with no Lewis base additives during oxidative polymerization.

PEDT was synthesized at different temperatures to investigate the effect of the polymerization temperature on voltage-current (V-i) curve. The melting point of p-toluenesulfonic acid is about 105 degree centigrade, so that the oxide film is not be damaged by molten p-toluenesulfonic acid if polymerization reaction is carried out below the melting point as diffusion of solid p-toluenesulfonic acid is likely to be limited.

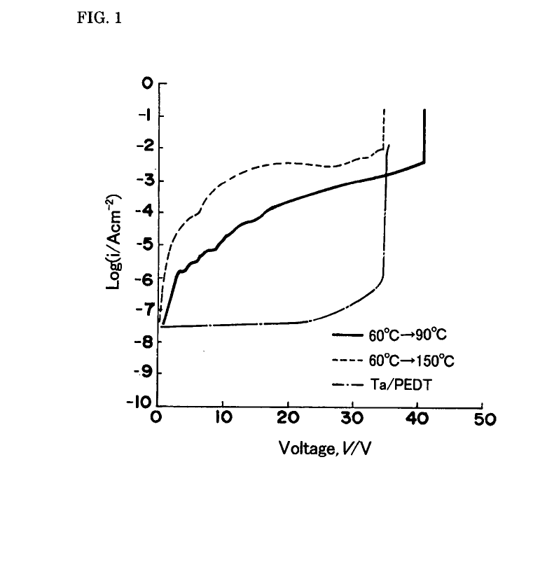

FIG. 1 shows the voltage-current curve of an Al/oxide₄₀ᵥ/PEDT capacitor with polymer prepared at 90 degree centigrade and 150 degree centigrade in heat treatment twice. In FIG. 1, the voltage-current curve of a Ta/PEDT capacitor is also shown as a comparative.

In the case of the Ta/PEDT capacitor, the charging current, which was almost independent of the applied voltage corresponding to its capacitance, flew at low voltage (low electric field). Then the current exponentially increased, and finally a current jump occurred near oxide formation voltage. When ramp voltage was applied from 0 V again on the sample after the current jump occurred, the current increased linearly with the applied voltage. That is, the current increased according to Ohm's law. This indicates that the sample was short circuited, i.e., breakdown occurred at the time of the current jump.

Additionally, in the case of the Al/PBDT in the absence of sterically hindered Lewis base additives in which the heat treatment was carried out at both the temperatures described above, much higher (a few orders of magnitude) current flowed as compared with the Ta/PEDT capacitor even at low voltage. The Al/PEDT capacitor prepared at 90 degree centigrade showed lower leakage current than that prepared at 150 degree centigrade, but the current was still much higher than that of the Ta/PEDT. The breakdown (current jump) voltage was close to the oxide film formation voltage, i.e., similar to the Ta/PEDT capacitor, for both the heat treatment temperatures, although the leakage current was much higher than the Ta/PEDT.

### Comparative Example

There is shown an example in which pyridine is added as a Lewis base during oxidative polymerization to the conventional example, and the effect of a Lewis base on, a voltage-current property is shown below.

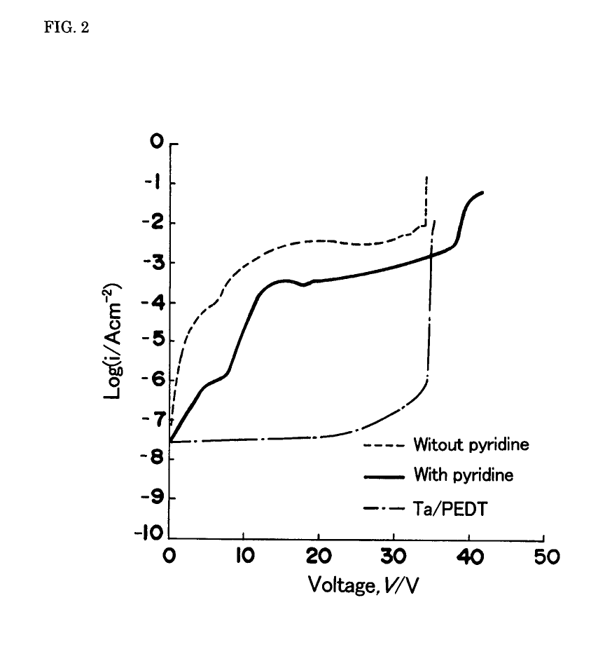

FIG. 2 shows voltage-current curves of an Al/PEDT capacitor, where the PEDT was synthesized with and without pyridine in the oxidant. As a comparative example, a voltage-current curve of a Ta/PEDT capacitor with a 40 V oxide film is also shown. The addition of pyridine somewhat reduces the current density. However, the value was much higher than that of the Ta/PEDT capacitor. This indicates that the addition of pyridine did not work for protecting an Al oxide film from a chemical attack by protons.

### Example 1

Example 1 examines the effect on a voltage-current property in which 2,6-dimethylpyridine is substituted for pyridine in the Comparative example described above.

It is examined about the voltage-current curve of an Al/PEDT capacitor with different oxide formation voltage, for example 40, 70 and 100V with PEDT synthesized with an oxidant containing 2,6-dimethylpyridine. Although spikes of current are observed at very low voltage (a few volts) and middle voltage (0.6 V_{f} or lower), and no spikes after the first charge (later charges show no current spikes due to reformation), the general phenomena is very similar to that of a Ta/PEDT capacitor. In other words, constant charging current flows first, then increases exponentially near formation voltage (near 40, 70 and 100 V), and finally breaks down. As a result, the oxide was protected from proton attack, and a good voltage-current property close to that of the Ta/PEDT capacitor was obtained.

### Example 2

The Example 2 examines the effect on a voltage-current property in which 3,5-dimethylpyridine is substituted for the 2,6-dimethylpyridine in Example 1 described above.

The voltage-current curve of an Al/PEDT capacitor with different oxide formation voltage, for example 40, 70 and 100V, was examined with PEDT synthesized with an oxidant containing 3,5-dimethylpyridine in the same manner as the above Example 1. Methyl substitutions at 3- and 5-position are away from the ring nitrogen, so that interaction with the iron (III) oxidant is expected. At low voltage (less than 0.5 to 0.6 V_{f}), constant charging current flowed similarly to the Al/PEDT capacitor with the 2,6-dimethylpyridine in Example 1. However at voltage above 0.5 to 0.6 V_{f}, leakage current increased, and then breakdown occurred near formation voltage (near 40, 70 and 100 V). With this feature, the addition of 3,5-dimethylpyridine provided better results than the addition of pyridine, but worse results than the addition of 2,6-dimethylpyridine. For this reason, the highest additive effect on the voltage-current property of the Al/PEDT capacitor was shown with the use of 2,6-dimethylpyridine, followed by 3,5-dimethylpyridine. The addition of pyridine brought about no changes.

FIGS. 1 and 2 and Examples 1 and 2 show that in the Conventional example (FIG. 1) and the Comparative example (FIG. 2), current flows together with voltage application, and in Examples 1 and 2, voltage increases even when no current flows, with the voltage resistance property enhanced. Furthermore, Example 1 shows better properties than Example 2.

### Example 3

Example 3 examines the effect on a voltage-current property in which triisopropanolamine (formula 4) is substituted for 2,6-dimethylpyridine in Example 1 described above and also tributylamine (formula 5) is used as Comparative example 2. The oxide formation voltage is 100 V.

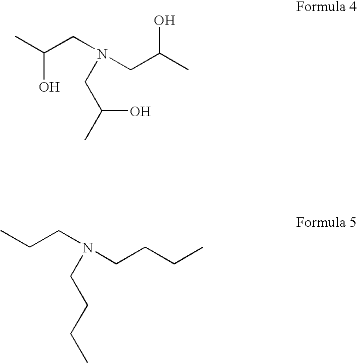

Tables 1 to 4 show voltage-current properties of an Al/PEDT capacitor with film formation voltage different from PEDT synthesized with oxidant with a hindered Lewis base and without a Lewis base, to which verification experiments were carried out.

Table 1 shows a film formation voltage of 40 V. Table 2 shows a film formation voltage of 70 V. Table 3 and 4 show a capacitor with a film formation voltage of 100 V. It should be noted that Example (1) shows the addition of 2,6-dimethylpyridine to the oxidant, that Example (2) shows the addition of 3,5-dimethylpyridine to the oxidant, that Comparative example (1) shows the addition of pyridine to the oxidant, that Example (3) shows the addition of triisopropanolamine, that Comparative example (2) shows the addition of tributylamine to the oxidant and that the Conventional example shows no additives being added to the oxidant.

TABLE 1

Applied voltage (V)

| | 5 | 30 | 40 | 42 |
|---|---|---|---|---|
| Example (1) log(I/Acm⁻²) | −7.5 | −7 | −6.5 | −4 |
| Example (2) log(I/Acm⁻²) | −7.5 | −6 | −5.5 | −4 |
| Comparative example | −6 | −3.5 | −3 | −1 |
| log (I/Acm⁻²) | | | | |
| Conventional example | −4 | −2 | — | — |
| log (I/Acm⁻²) | | | | |

TABLE 2

| | Applied voltage (V) | | | | |
|---|---|---|---|---|---|
| | 25 | 30 | 50 | 70 | 72 |
| Example (1) log(I/Acm⁻²) | −7.5 | −7.5 | −7.5 | −7.5 | −4 |
| Example (2) log(I/Acm⁻²) | −7.5 | −6 | −4.5 | −4.5 | −3.5 |
| Conventional example | −3.5 | −3 | — | — | — |
| log(I/Acm⁻²) | | | | | |

TABLE 3

Applied voltage (V)

| | 60 | 62 | 90 | 92 |
|---|---|---|---|---|
| Example (1) log(I/Acm⁻²) | −7.5 | −7.5 | −6.5 | −2.5 |
| Example (2) log(I/Acm⁻²) | −7.5 | −6 | −6 | −2 |
| Conventional example | −1.5 | — | — | — |
| log (I/Acm⁻²) | | | | |

TABLE 4

| | Applied voltage (V) | | | | |
|---|---|---|---|---|---|
| | 5 | 30 | 60 | 80 | 82 |
| Example (3) log(I/Acm⁻²) | −8.0 | −7.0 | −7.0 | −6.0 | −2.0 |
| Comparative example (2) | −4.0 | −3.0 | — | — | — |
| log(I/Acm⁻²) | | | | | |
| Conventional example | −4.0 | −2.5 | — | — | — |
| log(I/Acm⁻²) | | | | | |

These tables reveal that the highest additive effect on the voltage-current properties of the Al/PEDT capacitor was shown with the use of 2,6-dimethylpyridine, followed by 3,5-dimethylpyridine, even in the case of using a capacitor with different formation voltage. The addition of pyridine brought about no changes, as compared the examples with no additives.

Further, the addition of triisopropanolamine brought about highly beneficial additive effect at the high formation voltage of 100 V. The addition of tributylamine brought about no changes. This is the same result as occurred with the use of no additives.

### Example 4

An anodic electrode foil formed of a dielectric oxide film layer by applying the formation voltage with 90 V to the surface and a cathodic electrode foil are connected with an electrode extracting means and both electrode foils are wound via a separator to form a capacitor element. EDT and iron (III) p-toluenesulfonate butanol solution are mixed. The capacitor element is impregnated with the mixture. It is then heated at 150 degree for 60 minutes and the polymerization reaction of PEDT occurred in the capacitor element resulting in the formation of a solid electrolyte layer.

The capacitor element is introduced into an outer package in a closed-end cylindrical form. Further, a sealing member made of elastic rubber is engaged with the open-end section of the package and sealed by using a drawing process, whereby a solid electrolyte layer is constituted. Thereafter, electrical aging is carried out by applying the current whereby a solid electrolytic capacitor is constituted. The rated voltage of the solid electrolytic capacitor is 25 WV; its rating capacity is 10 μF. This solid electrolytic capacitor is compared with the Conventional example.

### Example 4-1

A solid electrolytic capacitor is constituted in the same manner as that of the Conventional example other than that the capacitor element is impregnated with 2,6-dimethylpyridine ethanol solution before drying.

### Example 4-2

A solid electrolytic capacitor is constituted in the same manner as that of the Conventional example other than that 2,6-dimethylpyridine is added in the EDT and iron (III) p-toluenesulfonate butanol solution mixture, and a 10 wt % solution.

A voltage (insulation breakdown voltage) is measured by applying the rated voltage 25 V to these solid electrolytic capacitors and increasing the applying voltage with the current value of 50 mV/sec until insulation breakdown occurred. The results are shown in Table 5.

TABLE 5

| | insulation breakdown voltage |
|---|---|
| | (V) |
| Example (1) | 68 V |
| Example (2) | 67 V |
| Conventional example log | 57 V |

As shown in Table 5, the voltage resistance property of the Examples compared to the Conventional example has a improvement higher than 10 V and the improved effect on the voltage resistance property of the present invention is indicated.

As has been described above concerning solid electrolytic capacitors, forming an electrolyte layer on the anode electrode formed of aluminum oxide dielectric by a polymerization reaction in which the polymerizable monomer or the monomer solution is mixed with an oxidant, the electrical resistance of the solid electrolytic capacitor can be increased exponentially by adhering a Lewis base having a steric hindrance group with a nitrogen atom or a Lewis base having a hydrophilic radical with a nitrogen atom to a surface of the dielectric, or by incorporating them in the electrolyte layer.

### Example 5

Samples of ferric tosylate oxidant 54% in butanol (Baytron® CB54) were mixed with EDOT monomer (Baytron® MV2) and coated on glass slides and left until cured. The stoichiometric ratio of monomer:oxidant was kept at 1:0.34. The stoichiometric ratio of the sterically hindered Lewis base 2,6-lutidine:oxidant (n_{LB}/nₒₓ) was varied from 0 to 1.5. The reaction solution area was masked around the perimeter with silicone masking agent to an approximate rectangular dimension of two cm per side. The cured hardened PEDOT polymers were coated with conductive silver paste which was left to dry. The specific conductivities were then measured with a two point probe technique. Obtained results are shown below in Table 6.

TABLE 6

| n_{LB}/n_{OX} | Specific conductivity (Scm⁻¹) |
|---|---|
| 0.0 | 0.1 |
| 1.0 | 5.5 |
| 1.2 | 3.0 |
| 1.5 | 0.2 |

To determine the improvement in oxide stability due to the addition of 2,6-lutidine laboratory capacitors were built and tested for short circuit voltage with n_{LB}/nₒₓ, of 1.4. The reaction mixture was coated on etched Al with an oxide dielectric formed at 93.3 V. Capacitors without 2,6-lutidine exhibited short circuit voltages of 40 V+/−10%. Capacitors with the 2,6-lutidine additive exhibited dramatically higher short circuit voltage of 80 V+/−10%.

1. A solid electrolytic capacitor comprising an electrolyte layer on an anode electrode formed of a valve metal oxide dielectric by a polymerization reaction wherein an oxidative polymerizable monomer or an oxidative polymerizable monomer solution is mixed with an oxidant, and wherein a Lewis base having a steric hindrance group, including a nitrogen atom, is adhered to a surface of the dielectric.

2. The solid electrolytic capacitor according to claim 1, wherein said Lewis base comprises 2,6-dimethylpyridine.

3. A solid electrolytic capacitor comprising an electrolyte layer on an anode electrode formed of a valve metal oxide dielectric by a polymerization reaction in which an oxidative polymerizable monomer or an oxidative polymerizable monomer solution is mixed with an oxidant, wherein a Lewis base having a hydrophilic radical including a nitrogen atom is adhered to a surface of the dielectric.

4. The solid electrolytic capacitor according to claim 3, wherein said Lewis base comprises triisopropanolamine.

5. The solid electrolytic capacitor according to claim 1, wherein said oxidative polymerizable monomer comprises 3,4-ethylenedioxythiophene.

6. A method of manufacturing of a solid electrolytic capacitor comprising forming an electrolyte layer on an anode electrode formed of an aluminum oxide dielectric by a polymerization reaction wherein an oxidative polymerizable monomer or an oxidative polymerizable monomer solution is mixed with an oxidant, wherein a Lewis base having a steric hindrance group with a nitrogen atom is adhered to a surface of the dielectric, and then the polymerization reaction is performed.

7. A method of manufacturing of a solid electrolytic capacitor comprising forming an electrolyte layer on an anode electrode formed of an aluminum oxide dielectric by a polymerization reaction in which an oxidative polymerizable monomer or an oxidative polymerizable monomer solution is mixed with an oxidant, wherein a Lewis base having a hydrophilic radical with a nitrogen atom is adhered to a surface of the dielectric, and then the polymerization reaction is performed.

8. A solid electrolytic capacitor comprising an electrolyte layer on an anode electrode formed of a metal oxide dielectric by a polymerization reaction wherein an oxidative polymerizable monomer or an oxidative polymerizable monomer solution is mixed with an oxidant, and wherein a Lewis base having a steric hindrance group with nitrogen atom is contained in the electrolyte layer.

9. The solid electrolytic capacitor according to claim 8, wherein said Lewis base comprises 2,6-dimethylpyridine.

10. A solid electrolytic capacitor comprising an electrolyte layer on an anode electrode formed of a valve metal oxide dielectric by a polymerization reaction in which an oxidative polymerizable monomer or an oxidative polymerizable monomer solution is mixed with an oxidant, wherein a Lewis base having a hydrophilic radical including a nitrogen atom is contained in the electrolyte layer.

11. The solid electrolytic capacitor according to claim 10, wherein said Lewis base comprises triisopropanolamine.

12. The solid electrolytic capacitor according to claim 8, wherein said oxidative polymerizable monomer comprises 3,4-ethylenedioxythiophene.

13. A method of manufacturing of a solid electrolytic capacitor comprising forming an electrolyte layer on an anode electrode formed of an aluminum oxide dielectric by a polymerization reaction in which an oxidative polymerizable monomer or an oxidative polymerizable monomer solution is mixed with an oxidant, wherein the method comprises including a Lewis base having a steric hindrance group containing a nitrogen atom in a polymerization reaction liquid and polymerizing the resultant mixture.

14. A method of manufacturing of a solid electrolytic capacitor comprising forming an electrolyte layer on an anode electrode formed of an aluminum oxide dielectric by a polymerization reaction in which an oxidative polymerizable monomer or an oxidative polymerizable monomer solution is mixed with an oxidant, wherein the method comprises including a Lewis base having a hydrophilic radical containing a nitrogen atom in a polymerization reaction liquid and polymerizing the resultant mixture.

15. The solid electrolytic capacitor according to claim 3, wherein said oxidative polymerizable monomer comprises 3,4-ethylenedioxythiophene.

16. The solid electrolytic capacitor according to claim 10, wherein said oxidative polymerizable monomer comprises 3,4-ethylenedioxythiophene.
